(19) United States
(12) Patent Application Publication
(10) Pub. No.: US 2016/0125553 A1
(43) Pub. Date: May 5, 2016

(54) SYSTEM OF MANAGING AND ANALYZING IRS ACCOUNT DATA

(71) Applicant: Roger William NEMETH, Tallahassee, FL (US)

(72) Inventor: Roger William NEMETH, Tallahassee, FL (US)

(21) Appl. No.: 14/529,223

(22) Filed: Oct. 31, 2014

(51) Int. Cl. G06Q 40/00; G06F 17/30

(52) U.S. Cl. CPC G06Q 40/123; G06F 17/30424

(57) ABSTRACT

A system for managing a plurality of IRS-generated tax transcripts is provided. Each tax transcript may be populated with a plurality of tax data from a variety of sources, such as the plurality of tax forms provided to the IRS. The plurality of tax data may comprise a plurality of fixed data fields and a plurality of transaction events. The system may comprise a computer having a user interface; and a program product comprising machine-readable program code for causing, when executed, the computer to perform the following process steps: prompting a user to set at least one parameter for the identification of each tax transcript, wherein each tax transcript may comprise a plurality of fixed data fields and a plurality of transaction events; importing each tax transcript identified by the at least one parameters set by the user; parsing each tax transcript of each fixed data field and each transaction event so that the plurality of fixed data fields and the plurality of transaction events may be mapped to a formatted data template providing a plurality of formatted tax data; sequencing the plurality of formatted transaction events into chronological order; running logic processes and queries against the plurality of formatted tax data; returning a value of each logic processes and queries, resulting in a plurality of logic values; and producing an electronic representation of the plurality of logic values in a desired format.

### BACKGROUND OF THE INVENTION

The present invention relates to data management and, more particularly, to a system of managing and analyzing IRS account data.

For tax purposes, every individual and business taxpayer in the United States has a tax with the U.S. Department of the Treasury. The Internal Revenue Service (IRS) makes this account data available in a plurality of raw data documents called tax transcripts. Generally there are four types of tax transcripts: account transcripts, return transcripts, wage and income transcripts, and record of account transcripts.

Tax return transcripts show most line items from the taxpayer's tax return as it was originally filed, including any accompanying forms and schedules. This transcript does not reflect any changes the taxpayer, taxpayer's representative or the IRS made after the taxpayer filed their return.

Tax account transcripts provide any account transactional data including, but not limited to credit or debit adjustments either the taxpayer or IRS made. This transcript shows basic data, including marital status, type of return filed, adjusted gross income and taxable income. This transcript also shows events that accurred on the taxpayer's account including, but not limited to audits, legal actions such as bankruptcy filings, collection resolution processes, and irs notices issued. Wage and income transcripts show data from information returns, such as W-2s, 1099s and 1098s, reported to the IRS. This transcript shows all reported income for the taxpayer that has been reported as well but not limited to mortgage interest and student loan interest, and college tuition and scholarships.

Record of account transcripts combine the information from tax account and tax return transcripts.

Each tax transcript may be populated with a plurality of tax data from a variety of sources, such as the plurality of tax forms provided to the IRS in reference to the tax account. The plurality of tax data may comprise at least one fixed data field, a at least one transaction event, credit/debit account information and the like.

Taxpayers routinely need to access and provide the plurality of tax data to others when, for example, applying for loans, such as, but not limited to, student loans, personal loans, SBA loans, business loans, and mortgages, addressing IRS audits, tax account and collection issues, applying for citizenship, resolving or checking for identity theft, applying for security clearance, health insurance queries in reference to the Affordable Care Act (ACA), applying for employment, calculating debt discharge eligibility and discharge dates under bankruptcy code and the like.

Unfortunately, these tax transcripts are so disorganized, even trained tax professionals have difficulty interpreting and understanding them. Moreover, the tax transcripts are plentiful as they are produced every predetermined period. The most common predetermined period is yearly, but some are available quarterly. So, for example, if an individual were to acquire all of their available tax transcripts, going back fifteen years they may have over 100 separate documents. And since each tax transcript can range from one page to well over one-hundred pages, this makes reviewing the tax transcripts a time consuming process.

Currently, the only process to manage the plurality of tax data is to manually review each document and/or moving this data manually in a time consuming and risky manner. The individual reviewing the plurality of tax transcripts can review each document individually or they can transfer the data manually into a spreadsheet application for comparison between the predetermined periods. This copying and pasting process can take hours or days depending on the plurality of tax data that needs to be reviewed and/or analyzed, requiring a large number of man hours. Using the spreadsheet application also has the risk of that certain values of the plurality of tax data being changed erroneously during the process causing invalid or inaccurate results.

As can be seen from the importance of managing the plurality of IRS tax transcripts for every single U.S. taxpayer desiring to apply for a loan, mortgage, employment and/or address audit and collection issues, there is a long felt need for a system that quickly imports, validates, filters, consolidates, formats, sequences and runs logic queries on the plurality of tax data contained in the plurality of tax transcripts so as to produce output relevant to the logic queries in a desired format.

### SUMMARY OF THE INVENTION

In one aspect of the present invention, a system for managing at least one tax transcript, wherein each tax transcript includes a plurality of tax data comprising at least one transaction event, at least one fixed data field or a combination thereof, and each transaction event has an associated transaction date, the system comprises: a computer having a user interface; and a program product comprising machine-readable program code for causing, when executed, the computer to perform the following process steps: prompting via the user interface a user to set at least one parameter for the identifying the plurality of tax transcripts; identifying at least one matching tax transcript matching the at least one parameter; importing each matching tax transcript; parsing the plurality of tax data from each matching tax transcript for mapping into a formatted data template; formatting each tax data field into the formatted data template, wherein the formatted data template provides a plurality of new data sets populated by the plurality of transaction events; sequencing the plurality of new data sets into chronological order as a function of the corresponding associated transaction dates; running a plurality of logic processes and queries against the new data sets; returning a logic value of each of the logic processes and queries, resulting in a plurality of logic values; summing and weighting the plurality of logic values according to a predetermined analysis; and producing an electronic representation in a desired format of the results of the predetermined analysis.

In another aspect of the present invention, a system for managing at least one tax transcript, wherein each tax transcript includes a plurality of tax data comprising at least one transaction event, at least one fixed data field or a combination thereof, and each transaction event has an associated transaction date, the system comprises: a computer having a user interface; and a program product comprising machine-readable program code for causing, when executed, the computer to perform the following process steps: receiving at least one matching tax transcript; parsing the plurality of tax data from each matching tax transcript for mapping into a formatted data template; formatting each tax data into the formatted data template, wherein the formatted data template provides a plurality of new data sets populated by the plurality of transaction events; and sequencing the plurality of new data sets into chronological order as a function of the corresponding associated transaction dates.

These and other features, aspects and advantages of the present invention will become better understood with reference to the following drawings, description and claims.

### BRIEF DESCRIPTION OF THE DRAWINGS

FIG. 1 is a schematic view of an exemplary embodiment of the present invention;

FIG. 2 is a flow chart of an exemplary embodiment of the present invention;

FIG. 3 is a flow chart of an exemplary embodiment of the present invention;

FIG. 4 is a flow chart of an exemplary embodiment of the present invention;

FIG. 5 is a flow chart of an exemplary embodiment of the present invention;

FIG. 6 is a flow chart of an exemplary embodiment of the present invention; and

FIG. 7 is a flow chart of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a system for managing a plurality of IRS-generated tax transcripts. Each tax transcript may be populated with a plurality of tax data from a variety of sources, such as the plurality of tax forms provided to the IRS. The plurality of tax account data may comprise a plurality of fixed data fields and a plurality of transaction events. The system may comprise a computer having a user interface; and a program product comprising machine-readable program code for causing, when executed, the computer to perform the following process steps: prompting a user to set at least one parameter for the identification of each tax transcript, wherein each tax transcript may comprise a plurality of fixed data fields and a plurality of transaction events; importing each tax transcript identified by the at least one parameters set by the user; parsing each tax transcript of each fixed data field and each transaction event so that the plurality of fixed data fields and the plurality of transaction events may be mapped to a formatted data template providing a plurality of formatted tax data; sequencing the plurality of formatted transaction events into chronological order; running logic processes and queries against the plurality of formatted tax data; returning a value of each logic processes and queries, resulting in a plurality of logic values; and producing an electronic representation of the plurality of logic values in a desired format.

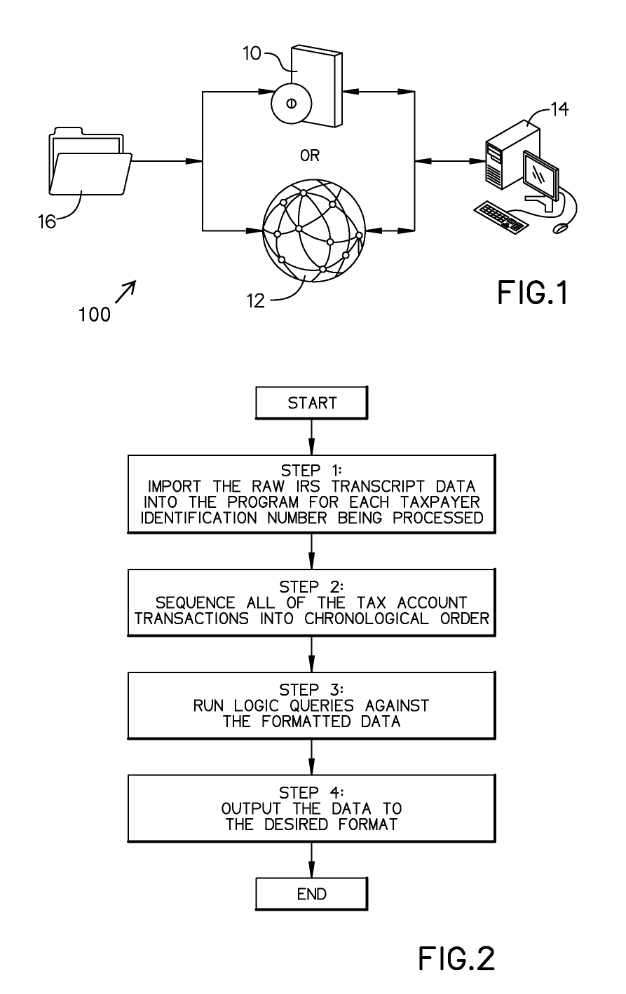

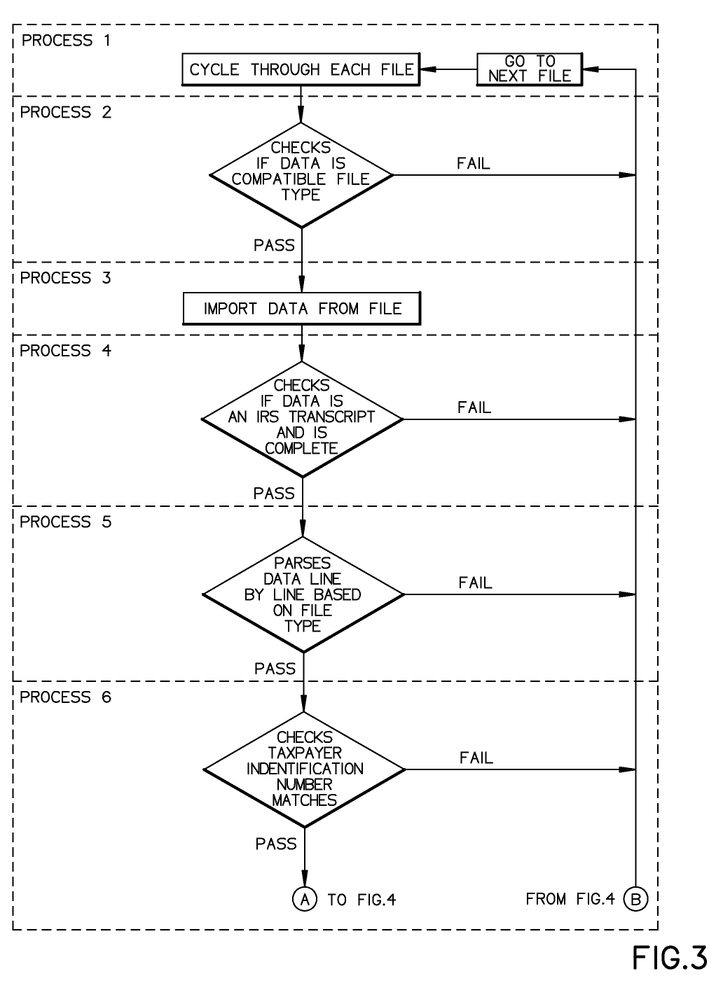

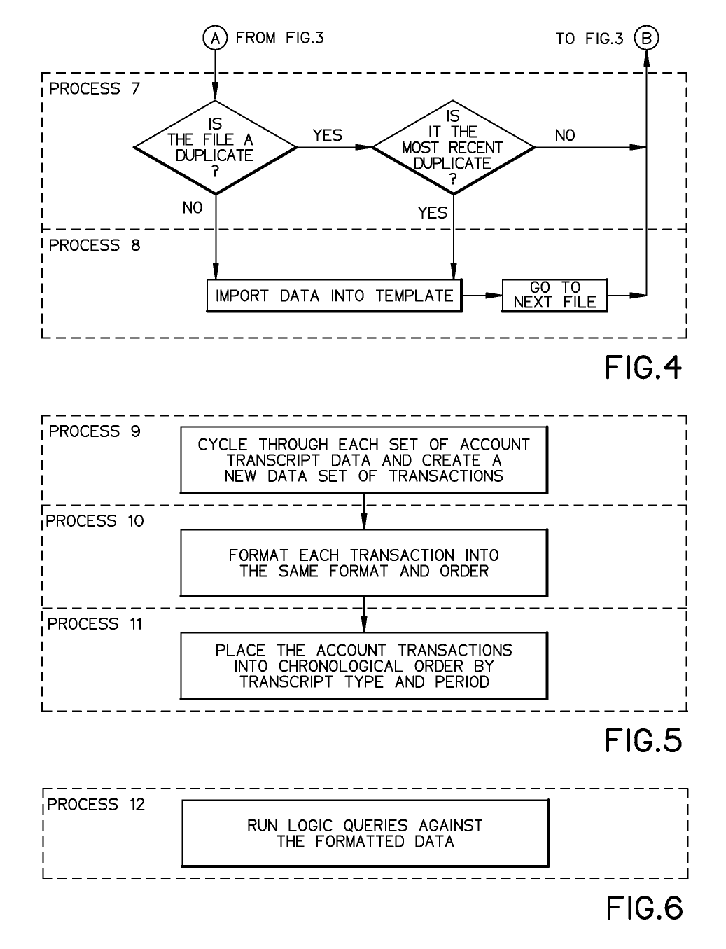

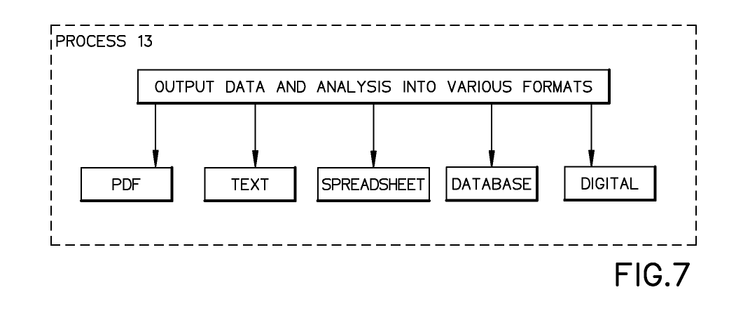

Referring to FIGS. 1 through 7, the present invention may include a tax transcript management system 100. The tax transcript management system 100 may include at least one computer 14 with a user interface. The computer 14 may include at least one processor connected to a form of memory. The computer 14 may include, but not limited to, a desktop, laptop, and smart device, such as, a tablet and smart phone. The computer 14 includes a program product 10 including a machine-readable program code for causing, when executed, the computer 14 to perform steps. The program product 10 may include software which may either be loaded onto the computer 14 or accessed by the computer 14. The loaded software may include an application on a smart device. The software may be accessed by the computer 14 using a web browser. The computer 14 may access the software via a network 12, such as through the web browser using the internet, extranet, intranet, host server, internet cloud and the like.

For tax purposes, every individual and business taxpayer in the United States has a tax with the U.S. Department of the Treasury that is associated with a Taxpayer Identification Number (TIN). The Internal Revenue Service (IRS) makes this account data available in a plurality of raw data documents called tax transcripts. Generally there are four types of tax transcripts: account transcripts, return transcripts, wage/income transcripts, and record of account transcripts. Each tax transcript has an associated TIN. Each tax transcript may be populated with a plurality of taxdata from a variety of sources, such as the plurality of tax forms provided to the IRS. The plurality of tax data may comprise a plurality of fixed data fields and a plurality of transaction events. Generally, a fixed data field may have a definition followed by a fixed value. For example, “First Name:” followed by “John,” with “John” being the fixed value for that specific fixed data field definition throughout the plurality of tax transcripts. Generally, a transaction event may be any event tax-related event that affected the IRS tax, for example a refund was issued by the IRS to the tax. Each transaction event may have an associated transaction code, associated transaction description, associated transaction amount and associated cycle value. Importantly, each transaction event has an associated transaction date.

The transcript management system 100 may be configured to receive/import a plurality of tax transcripts. In certain embodiments, each transcript may be received by the transcript management system 100 through the computer and/or the user interface which would capture input from a user through keyboard and/or mouse entries, through importation of batch files generated by another computer or system, through command line interface or the like.

The transcript management system 100 may prompt the user for at least one parameter for identifying at least one tax transcript. The at least one parameter may include, but not limited to, at least one associated TIN, at least one folder and/or file location, the associated or a range of associated transaction dates, or the like. In certain embodiments, at least one associated TIN may be received/imported into the transcript management system 100 during the process of receiving/importing the plurality of transcripts pursuant to the at least one parameter that does not include the at least one associated TIN.

Once the transcript management system 100 is activated and the required parameters are passed thereto the following steps may be performed for each transcript:

STEP 1: Import at least one tax transcript into the transcript management system 100 for each associated TIN being processed; and parsing each tax transcript of each fixed data field and each transaction event so that the plurality of fixed data fields and the plurality of transaction events may be mapped to a formatted data template providing a plurality of formatted tax data.

STEP 2: Sequence the plurality of transaction events of the plurality of formatted tax data into chronological order;

STEP 3: Run a plurality of logic processes and queries against the plurality of formatted tax data; returning a logic value of each logic processes and queries, resulting in a plurality of logic values; and

STEP 4: Produce an electronic representation of the plurality of logic values in a desired format.

### STEP 1

Import at least one tax transcript into the transcript management system 100 for each associated TIN being processed; and parsing each tax transcript of each fixed data field and each transaction event so that the plurality of fixed data fields and the plurality of transaction events may be mapped to a formatted data template providing a plurality of formatted tax data:

In sub-process 1, the system 100 may cycle through a tax transcript database to identify at least one tax transcript matching the at least one parameter set by the user. Once each TIN may be provided by the at least one parameter or provided by at least one tax transcript otherwise matching the at least one parameter, the system may create a transcript folder 16 associated with each TIN for saving each tax transcript associated with said TIN.

In sub-process 2, the system 100 may verify if each identified tax transcript of sub-process 1 is a correct type. For example, if the identified tax transcript is a file, sub-process 2 verifies if the file type is html or PDF.

In sub-process 3, if sub-process 2 passes, the transcript folder 16 may be imported into the system 100.

In sub-process 4, the system 100 may check each tax transcript of each transcript folder 16 to determine whether each is a complete tax transcript and in a proper format.

In sub-process 5, each tax transcript is parsed to convert each fixed data field and each transaction event therein to a uniform format.

In sub-process 6: If sub-process 5 passes, the TIN associated with each tax transcript is compared to the TIN of the transcript folder 16. This sub-process may check that the tax data being imported is for the TIN being presently processed.

In sub-process 7: If sub-process 6 passes, each tax transcript may be compared to other tax transcripts for duplication. If the plurality of credit/deficit account data from one tax transcript matches the plurality of credit/deficit account data of another tax transcript from the transcript folder 16 (or another tax transcript earlier imported) each having the same predetermined period (yearly, quarterly or the like) then the most recent plurality of credit/deficit account data is kept and the older plurality of credit/deficit account data is removed.

In sub-process 8: If sub-process 7 passes, the plurality of fixed data fields and the plurality of transaction events contained within the present transcript folder 16 may be mapped to a formatted data template providing a plurality of formatted tax data associated with said transcript folder 16 and its associated TIN.

### STEP 2

Sequence the plurality of transaction events of the plurality of formatted tax data into chronological order.

In sub-process 9, the system 100 may cycle through the plurality of formatted tax data for each transcript folder 16, culling each transaction event thereof and its associated transaction date into at least one new data set.

In sub-process 10, the system 100 may format each new data set into the same format and order, facilitating formatted transaction event data.

In sub-process 11, the system 100 may place each transaction event of the formatted transaction event data into chronological order based on its associated transaction date, facilitating organization by transcript type and the predetermined period.

### STEP 3

The system 100 may run a plurality of logic processes and queries against the plurality of formatted tax data and/or formatted transaction event data; returning a logic value of each logic processes and queries, resulting in a plurality of logic values.

In sub-process 12, the system 100 may be configured to apply the plurality of logic queries on each fixed data field and the chronological ordered formatted transaction event data, for each predetermined period, returning a plurality of logic values. The plurality of logic queries may include, but not be limited to, the following:
1. Was a return filed?
2. When was return filed?
3. What type of return was last filed (original, amended, or substitute for return)?
4. Total assessed debt?
5. Total accrued debt?
6. Total debt?
7. Total of each type of penalty?
8. Total interest?
9. In collections?
10. Active lien?
11. Released lien?
12. Lists all assessments.
13. Lists tolling events.
14. Calculates Collections Statute Expiration Date (CSED) for each assessment.
15. Calculates bankruptcy discharge dates for each assessment.
16. Calculates Assessment Statute Expiration Date (ASED).
17. Lists all letters and notices sent to taxpayer and reported on account transcript.
18. Lists all payments made by taxpayer on account.
19. Extension filed?
20. Extension date?
21. Active examination? (An IRS Audit)
22. Filing status?
23. Separate assessment present?
24. IRS adjustments made to tax return?
25. Amount of adjustment made to tax return?
26. How many of each type of reported income document?
27. Amounts of each type of reported income?
28. Number of corrected or amended income documents reported to IRS?
29. Calculates the total of each field in the wage and income transcripts.
30. Audit Red Flag Checks.
31. Qualify for tax credits.
32. Refund calculation looking for inaccurate refunds or tax credits.
   The formatted tax data and/or formatted transaction event data can be weighted and summed according to a predetermined analysis of the returned plurality of logic values. For example, a predetermined analysis may include the summation of returned plurality of logic values may be used to compare the values from predetermined fixed data fields and transaction events to known figures from the IRS that increase the chances of an audit. The tax returns can then be scored as to the increased chance of audit risk. The IRS scores tax returns for audit: (From the IRS) “Computer Scoring—Some returns are selected for examination on the basis of computer scoring. Computer programs give each return numeric “scores”. The Discriminant Function System (DIF) score rates the potential for change, based on past IRS experience with similar returns. The Unreported Income DIF (UIDIF) score rates the return for the potential of unreported income. IRS personnel screen the highest-scoring returns, selecting some for audit and identifying the items on these returns that are most likely to need review.” The present invention can review the tax return data and also assess the audit risk based on known factors from the IRS Statistics of Income and comparing them to a sample of known audits.

### STEP 4

The system 100 produce an electronic representation of the plurality of logic values, formatted tax data, formatted transaction event and/or the above mentioned value analysis in a desired output format.

In sub-process 13, the system 10 may produce the output format as a spreadsheet, a PDF document, a text document, a data file, a database file of the like. The output format can printed, viewed on a computer 14 screen, and electronically transmitted.

The system 100 may be configured to produce a tax data analysis report. The output data could also be uploaded to another process that could run additional logic queries and analysis. One such query would be to score the difficulty of the tax resolution solution needed to resolve any account issues. Health insurance companies could use the data to determine federal subsidies for health care as well as other qualifying factors in relation to the new health care reform. Mortgage brokers (and other loan officers) could use the data from the report to automate income verification. The Department of Homeland Security could use the software to monitor existing personnel with security clearances for IRS tax account issues. Bankruptcy attorneys could use the present invention to determine bankruptcy debt discharge eligibility and the calculated discharge eligibility dates.

The computer 14-based data processing system and method described above is for purposes of example only, and may be implemented in any type of computer 14 system or programming or processing environment, or in a computer 14 program, alone or in conjunction with hardware. The present invention may also be implemented in software stored on a computer 14-readable medium and executed as a computer 14 program on a general purpose or special purpose computer 14. For clarity, only those aspects of the system germane to the invention are described, and product details well known in the art are omitted. For the same reason, the computer 14 hardware is not described in further detail. It should thus be understood that the invention is not limited to any specific computer 14 language, program, or computer 14. It is further contemplated that the present invention may be run on a stand-alone computer 14 system, or may be run from a server computer 14 system that can be accessed by a plurality of client computer 14 systems interconnected over an intranet network, or that is accessible to clients over the Internet. In addition, many embodiments of the present invention have application to a wide range of industries. To the extent the present application discloses a system, the method implemented by that system, as well as software stored on a computer 14-readable medium and executed as a computer 14 program to perform the method on a general purpose or special purpose computer 14, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A system for managing at least one tax transcript, wherein each tax transcript includes a plurality of tax data comprising at least one transaction event, at least one fixed data field or a combination thereof, and each transaction event has an associated transaction date, the system comprising:
a computer having a user interface; and
a program product comprising machine-readable program code for causing, when executed, the computer to perform the following process steps:
prompting via the user interface a user to set at least one parameter for the identifying the plurality of tax transcripts;
identifying at least one matching tax transcript matching the at least one parameter;
importing each matching tax transcript;
parsing the plurality of tax data from each matching tax transcript for mapping into a formatted data template;
formatting each tax data field into the formatted data template, wherein the formatted data template provides a plurality of new data sets populated by the plurality of transaction events;
sequencing the plurality of new data sets into chronological order as a function of the corresponding associated transaction dates;
running a plurality of logic processes and queries against the new data sets;
returning a logic value of each of the logic processes and queries, resulting in a plurality of logic values;
summing and weighting the plurality of logic values according to a predetermined analysis; and
producing an electronic representation in a desired format of the results of the predetermined analysis.

2. The system for managing at least one tax transcript of claim 1, wherein the predetermined analysis includes the increased chance of audit risk based in part of the process the IRS scores tax returns for audit.

3. The system for managing at least one tax transcript of claim 1, wherein the predetermined analysis includes the determination of bankruptcy debt discharge eligibility and discharge eligibility dates.

4. A system for managing at least one tax transcript, wherein each tax transcript includes a plurality of tax data comprising at least one transaction event, at least one fixed data field or a combination thereof, and each transaction event has an associated transaction date, the system comprising:
a computer having a user interface; and
a program product comprising machine-readable program code for causing, when executed, the computer to perform the following process steps:
receiving at least one matching tax transcript;
parsing the plurality of tax data from each matching tax transcript for mapping into a formatted data template;
formatting each tax data into the formatted data template, wherein the formatted data template provides a plurality of new data sets populated by the plurality of transaction events; and
sequencing the plurality of new data sets into chronological order as a function of the corresponding associated transaction dates.

5. The system for managing at least one tax transcript of claim 4, further providing running a plurality of logic processes and queries against the new data sets.

6. The system for managing at least one tax transcript of claim 5, further providing returning a logic value of each of the logic processes and queries, resulting in a plurality of logic values.

7. The system for managing at least one tax transcript of claim 6, further providing and weighting the plurality of logic values according to a predetermined analysis.

8. The system for managing at least one tax transcript of claim 7, further providing producing an electronic representation in a desired format of the results of the predetermined analysis.

9. The system for managing at least one tax transcript of claim 8, wherein the predetermined analysis includes the increased chance of audit risk based in part of the process the IRS scores tax returns for audit.

10. The system for managing at least one tax transcript of claim 8, wherein the predetermined analysis includes the determination of bankruptcy debt discharge eligibility and discharge eligibility dates.

11. The system for managing at least one tax transcript of claim 4, further providing prompting via the user interface a user to set at least one parameter for the identifying the at least one matching tax transcripts.

12. The system for managing at least one tax transcript of claim 11, further providing identifying the at least one matching tax transcript matching the at least one parameter.
